(19) United States
(12) Patent Application Publication
(10) Pub. No.: US 2009/0162729 A1
(43) Pub. Date: Jun. 25, 2009

(54) Bipolar plate and method for manufacturing a protective layer on a bipolar plate

(75) Inventor: Thomas Kiefer, Bad Urach (DE)

Correspondence Address: Mr. Edward J. Timmer, P.O. Box 770, Richland, MI, 49083-0770, US

(73) Assignee: ElringKlinger AG

(21) Appl. No.: 12/316,054

(22) Filed: Dec. 9, 2008

(30) Foreign Application Priority Data
Dec. 14, 2007 (DE) 10 2007 060 272.5

(51) Int. Cl. H01M 2/16; B05D 3/02

(52) U.S. Cl. 429/34; 427/115

(57) ABSTRACT

In order to create a bipolar plate for a fuel cell unit, wherein the bipolar plate comprises a carrier layer and a protective layer, wherein the protective layer comprises an oxide system, the protective layer of which reliably reduces any chromium evaporation even during long-term operation and which also meets the remaining requirements placed on a bipolar plate, it is suggested that the oxide system of the protective layer be an at least ternary oxide system with at least three different types of metal cations.

The present disclosure relates to the subject matter disclosed in German patent application No. 10 2007 060 272.5 of Dec. 14, 2007. The entire specification of this earlier application is incorporated in the present specification by reference.

The present invention relates to a bipolar plate for a fuel cell unit, wherein the bipolar plate comprises a carrier layer and a protective layer, wherein the protective layer comprises an oxide system.

Since a fuel cell unit has only a low individual cell voltage of approximately 0.4 volts to approximately 1.2 volts (depending on the load), a series connection of several electrochemical cells in one fuel cell stack is required, whereby the initial voltage is scaled into a range which is interesting from the point of view of technical application. For this purpose, the individual electrochemical cells are connected by means of so-called bipolar plates (also designated as interconnectors).

Such a bipolar plate must fulfill the following requirements:
Distribution of the media (combustible gas and/or oxidizing agent).
Adequate electrical conductivity since the electrons generated on the hydrogen side (anode) are conveyed through the bipolar plates within the fuel cell stack in order to be available to the air side (cathode) of the next electrochemical cell. In order to keep the electrical losses low, the material for the bipolar plates must have an adequately high electrical conductivity.
Adequate corrosion resistance since the typical operating conditions of a fuel cell unit (operating temperature approximately 800° C., oxidizing/reducing atmosphere, humid air) promote corrosion. For this reason, the requirements placed on the corrosion resistance of the material of the bipolar plate are high.

Normally, ferritic, chromium oxide-forming stainless steels are used as material for the bipolar plate of high-temperature fuel cells. One reason for this is the relatively good electrical conductivity of the self-forming chromium oxide layer in comparison with the insulating oxide layers which are formed by other high-temperature steels or alloys (e.g., by aluminum oxide or silicone oxide forming agents).

When the temperature is increased, chromium oxide is formed on the surface of a chromium oxide-forming stainless steel. Volatile chromium compounds result from this chromium oxide under the operating conditions of a fuel cell. This “chromium volatilization” results in a poisoning of the cathode, in particular, during long-term operation of the fuel cell unit, whereby the current yield is drastically reduced.

In order to prevent chromium evaporation, it has already been suggested that certain elements (for example, Mn, Ni, Co) be doped into the steel of the bipolar plate, these elements influencing the growth of the oxide layer and converting the chromium oxide originally formed into a chemically stable form. As a result of such alloy additions, a minimization of the chromium evaporation can be achieved but not a lasting protection of the cathode.

Furthermore, it has already been suggested that the bipolar plates be coated with oxides or oxide mixtures (for example, oxides of Mn, Co, Cu). These layers are compacted by means of a subsequent temperature treatment on account of solid diffusion. Tests have shown that Mn, Fe and Cr diffuse out of the steel of the bipolar plate into such a protective layer and thereby provide for compaction. The compacted protective layer does, however, likewise contain chromium as a result of diffusion processes. It is, therefore, still possible for a chromium evaporation to occur, leading to an increased degradation of the cathode.

A further bipolar plate with a protective layer is known from the article of Zhenguo Yang, Guanguang Xia and Jeffry W. Stevenson: “Mn_{1.5}Co_{1.5}O₄ Spinel Protection Layers on Ferritic Stainless Steels for SOFC Interconnect Applications”, published in: Electrochemical and Solid-State Letters, Volume 8 (3), pages A 168 to A 170 (2005).

During the production of the bipolar plate known from this publication, a protective layer is generated by means of a sintering process of an oxide layer (Mn_{1.5}Co_{1.5}O₄) applied in a wet chemical process in a reducing atmosphere. With this process, a paste, which contains a binding agent and an oxide of the nominal composition Mn_{1.5}Co_{1.5}O₄, is applied to a steel material. The sintering takes place in two separate temperature treatment steps. During the first temperature cycle, the lattice structure of the protective layer is weakened by a reduction in the partial pressure of the oxygen, whereby a better sintering behavior occurs. In a separate, subsequent temperature treatment step the lattice structure is again oxidized completely, i.e., the missing oxygen is again incorporated into the lattice.

With this method for manufacturing a protective layer on a bipolar plate, the resulting microstructure of the protective layer has numerous pores and cracks. The protective layer thus manufactured therefore has no lasting chromium retention capability. In addition, the physical material properties of the protective layer, in particular, its electrical conductivity and the thermal expansion characteristics are not adapted in an optimum manner to the requirements placed on a bipolar plate for a fuel cell unit.

The object underlying the present invention is to create a bipolar plate of the type specified at the outset, the protective layer of which reliably reduces any chromium evaporation even during long-term operation and which also meets the remaining requirements placed on a bipolar plate.

This object is accomplished in accordance with the invention, in a bipolar plate having the features of the preamble to claim 1, in that the oxide system of the protective layer is an at least ternary oxide system with at least three different types of metal cations.

It has been shown that an improved microstructure of the protective layer and, therefore, an improved reduction in chromium diffusion through the protective layer and in chromium evaporation can be achieved as a result of the selection of an at least ternary oxide system for the protective layer in comparison with protective layers consisting of only binary oxide systems.

The oxide system of the protective layer preferably has a spinel structure.

It is favorable when the oxide system has at least one type of metal cation, the oxide of which is less stable than chromium oxide (its stability limit in the Ellingham diagram is, therefore, higher than the stability limit of chromium oxide).

Furthermore, it is favorable when the oxide system has at least one type of metal cation, the oxide of which is more stable than chromium oxide (its stability limit in the Ellingham diagram is, therefore, lower than the stability limit of chromium oxide).

In one preferred development of the invention it is provided for one type of metal cation of the oxide system of the protective layer to be Mn.

Furthermore, it is of advantage when one type of metal cation of the oxide system of the protective layer is Co or Cu.

Furthermore, it has proven to be particularly advantageous when one type of metal cation of the oxide system of the protective layer is Fe or Ni.

The microstructure (with respect to the reduction in cracks and pores) of the protective layer is improved, in particular, as a result of adding iron. The iron therefore acts positively on the sintering behavior of the protective layer. The improved microstructure of the protective layer is an indication for a greater freedom from defects of the protective layer. Since the diffusion of chromium is based, inter alia, on lattice defects, a sustained chromium retention is ensured by a protective layer which has fewer defects.

The addition of iron also reduces the thermal coefficient of expansion of the protective layer and, therefore, adapts it better to the thermal coefficient of expansion of the other components of the fuel cell unit. As a result, less mechanical tension results during a temperature cycle (heating up to operating temperature and cooling down) of the fuel cell stack.

Furthermore, a second temperature cycle during the manufacture of the protective layer in the sintering process can be omitted in the case of a protective layer containing iron. When only a single temperature cycle (instead of a first temperature cycle for the reduction of the protective layer and a second temperature cycle for the subsequent oxidation) has to be used, this has a positive effect on the production costs and on the microstructure of the protective layer.

In one preferred development of the invention it is provided for the oxide system to comprise Mn, Co and Fe cations.

It has proven to be particularly favorable when the oxide system has approximately the composition MnCo₂₋ₓFeₓO₄, where 0<x<1.

The oxide system with the approximate composition MnCo_{1.9}Fe_{0.1}O₄ has proven to be particularly favorable.

Alternatively to this, it can also be provided for the oxide system of the protective layer to comprise Mn, Cu and Fe cations.

The composition of the protective layer of the bipolar plate is preferably selected such that the thermal coefficient of expansion α of the protective layer is from approximately 10×10⁻⁶K⁻¹ to approximately 20×10⁻⁶K⁻¹, preferably from approximately 11.5×10⁻⁶K⁻¹ to approximately 13.5×10⁻⁶K⁻¹. Such a thermal coefficient of expansion is adapted particularly well to the thermal expansion behavior of the other components of the bipolar plate and the fuel cell unit.

The specific electrical conductivity σ of the protective layer is preferably from approximately 0.01 S/cm to approximately 200 S/cm.

The present invention relates, in addition, to a method for manufacturing a protective layer on a bipolar plate for a fuel cell unit.

The bipolar plate according to the invention is particularly suitable for use in a high-temperature fuel cell, in particular, an SOFC (Solid Oxide Fuel Cell) with an operating temperature of, for example, at least 600° C.

The additional object underlying the invention is to create such a method, whereby a protective layer is manufactured which has a good chromium retention capability even in long-term operation and also fulfills the other requirements to be met by a bipolar plate.

This object is accomplished in accordance with the invention by a method for manufacturing a protective layer on a bipolar plate for a fuel cell unit which comprises the following method steps:
Applying a layer consisting of a protective layer prematerial to a carrier layer of the bipolar plate;
generating a reduced partial pressure of the oxygen;
increasing the temperature to a sintering temperature;
subsequently increasing the partial pressure of the oxygen;
cooling the carrier layer and the protective layer formed thereon.

By sintering the protective layer in a reducing atmosphere, the sintering temperature (of normally up to 900° C.-1,100° C.) can be reduced (into the region of approximately 750° C. to approximately 800° C.). Furthermore, the sintering time (of normally 10 hours) can be shortened (to, for example, at the most approximately 3 hours). As a result, manufacturing costs can be saved and preliminary corrosive damage, in particular, as a result of the overgrowth of a Cr₂O₃ layer at an elevated temperature and a reduction in the electrical conductivity resulting therefrom can be reduced. Moreover, the chromium content in the steel material of the bipolar plate is prevented from dropping too sharply as a result of the overgrowth of a Cr₂O₃ layer and the steel material losing its corrosion resistance as a result.

The reducing atmosphere is preferably selected such that at least one of the metal oxides of the oxide system of the protective layer is unstable so that the associated metal cations have a higher reactivity while the reducing atmosphere is selected at the same time such that undesired elements from the basic material of the bipolar plate (in particular, chromium) are present in an oxidic form. The oxidic form means a higher chemical stability and, therefore, a lower reactivity. As a result, a compaction of the protective layer without any chromium diffusing into it can take place during sintering of the protective layer.

It is favorable when, in the first sintering phase, the temperature and the partial pressure of the oxygen are selected such that the status point in the Ellingham diagram defined by the sintering temperature and the sintering partial pressure of the oxygen is above the stability limit of chromium oxide but below the stability limit of at least one metal oxide, the metal cation of which is contained in the prematerial of the protective layer.

It is particularly favorable when the carrier layer with the prematerial is not cooled between the increase in the temperature to sintering temperature and the increase in the partial pressure of the oxygen. In this way, the protective layer can be manufactured in a single temperature cycle without any intermediate cooling to room temperature which has a positive effect on the manufacturing costs and the microstructure of the protective layer.

In one preferred development of the method according to the invention, the prematerial is applied to the carrier layer in a wet chemical manner.

In this respect, the prematerial can, for example, be sprayed onto the carrier layer or also be applied to the carrier layer in a screen printing process.

Additional, special developments of the method according to the invention are the subject matter of claims 16 to 23, the features of which have already been explained in the above in conjunction with the special developments of the bipolar plate according to the invention.

Additional features and advantages of the invention are the subject matter of the following description and the drawings illustrating embodiments.

In the drawings:

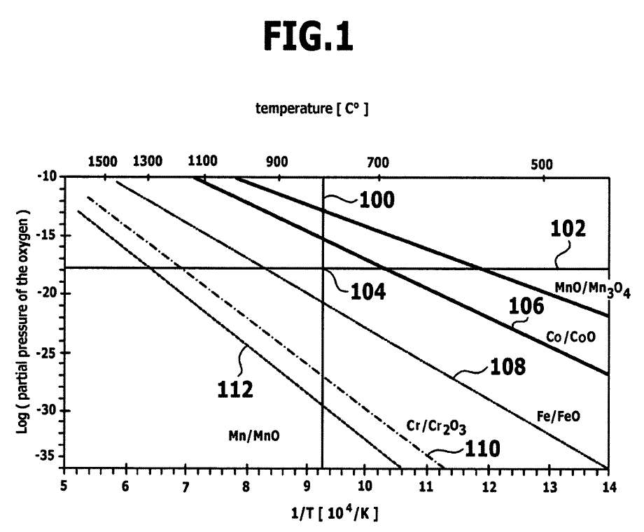

FIG. 1 shows an Ellingham diagram which shows the stability limits of the oxides of chromium, iron, cobalt and manganese in accordance with Ellingham;

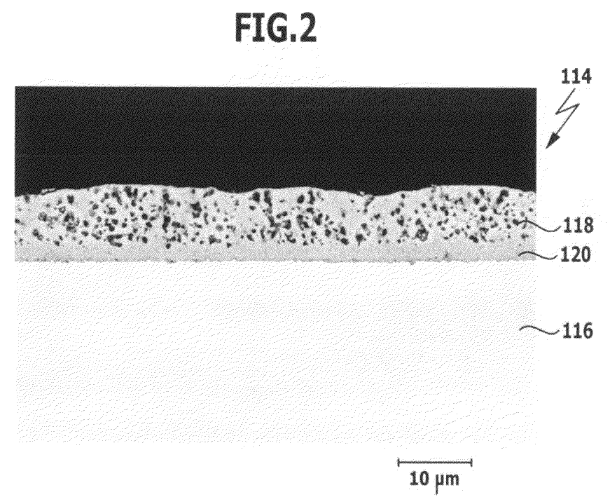

FIG. 2 shows a microscopic picture of a section through a substrate consisting of Crofer22 APU and a protective layer with the composition MnCo_{1.9}Fe_{0.1}O₄ which has been sintered for three hours in a reducing atmosphere at a sintering temperature of 800° C.; and

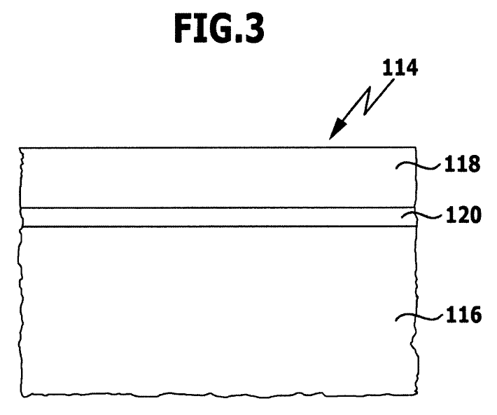

FIG. 3 shows a schematic section corresponding to FIG. 2 through a bipolar plate with a protective layer and an intermediate layer arranged between the protective layer and a basic material of the bipolar plate.

In order to manufacture the bipolar plate illustrated in FIG. 2 in a cutout longitudinal section, the procedure is as follows:

A carrier layer consisting of a ferritic, chromium oxide-forming stainless steel is made available, for example, from the stainless steel Crofer22 APU which has the following composition: 22.2% by weight of Cr; 0.46% by weight of Mn; 0.06% by weight of Ti; 0.07% by weight of La; 0.002% by weight of C; 0.02% by weight of Al; 0.03% by weight of Si; 0.004% by weight of N; 0.02% by weight of Ni, the rest iron.

In a first embodiment, a suspension is sprayed onto this carrier layer in a wet spraying process, this suspension having the following composition; 1 part by weight of a ceramic powder; 1.5 parts by weight of ethanol; 0.04 parts by weight of a dispersing agent (for example, Dolapix ET85); 0.1 parts by weight of a binding agent (for example, polyvinyl acetate, PVAC).

The ceramic powder for the suspension is produced as follows:

First of all, an amount of three different metal oxides, for example, Mn₂O₃, Co₃O₄ and Fe₂O₃ are weighed out such that the numerical ratio of the respective metal cations (e.g., Mn, Co, Fe) corresponds to the numerical ratio in the desired composition of the protective layer to be manufactured (e.g., 1:1.9:0.1 in the composition MnCo_{1.9}Fe_{0.1}O₄).

The weighed metal oxide powders are poured into a polyethylene bottle together with ethanol and ZrO₂ milling balls (with an average diameter of approximately 3 mm).

In this respect, the weight ratio of powder:ethanol:milling balls is approximately 1:2:3.

The polyethylene bottle is tightly closed and turned on a rolling bench for 48 hours.

In this respect, the rotational speed of the bottle is, for example, 250 rpm.

Following the specified rotation time, the grain size of the powder should be d₉₀=1 μm.

When the specified milling time of 48 hours is not sufficient for this purpose, the milling time must be extended accordingly.

A grain size of d₉₀=1 μm means that 90% by weight of the particles of the ceramic powder have a grain size of at the most 1 μm.

Once the desired grain size of the ceramic powder has been reached, the ZrO₂ milling balls are removed from the mixture and the ceramic powder is dried.

Subsequently, the ceramic powder is calcined at a temperature of 900° C. with a holding time of six hours. In this respect, the powder is heated up at a rate of heating of 3 K/min and following the holding time is cooled down in an unregulated manner (natural cooling).

The ceramic powder thus obtained is mixed with ethanol, dispersion agent and binding agent to form the suspension with the composition specified above.

The suspension thus obtained is sprayed onto the carrier layer through a spray nozzle in a wet spraying process.

In this respect, the diameter of the nozzle opening, with which the suspension is sprayed, is up to approximately 0.5 mm.

The spraying pressure, with which the suspension is conveyed to the nozzle, is, for example, 0.3 bars.

The spraying distance between the nozzle and the carrier layer (substrate) is, for example, 15 cm.

The nozzle is moved over the carrier layer with, for example, a speed of 230 mm/s.

The layer of the protective layer prematerial is applied to the carrier layer in two to four coating cycles, i.e., by spraying each surface area of the carrier layer two to four times.

Alternatively to the wet spraying process described above, a screen printing process can also be used to apply the ceramic powder to the carrier layer.

For such a screen printing process, a paste is produced which contains, for example, 50% by weight of the ceramic powder, 47% by weight of terpineol and 3% by weight of ethyl cellulose.

The ceramic powder is produced in the same way as that described above in conjunction with the wet spraying process.

In order to shorten the required milling time, 2-4% by weight (in relation to the weight of the ceramic powder) of a dispersion agent (for example, Dolapix ET85) can be added in order to achieve the specified grain size.

The components of the paste are homogenized in a roller mill.

Subsequently, the paste consisting of the protective layer prematerial is applied to the carrier layer of the bipolar plate by means of a screen printing unit known per se to the person skilled in the art.

The carrier layer with the layer consisting of the protective layer prematerial, which has been applied, for example, with a wet spraying process or a screen printing process, is sintered, first of all, during a subsequent temperature treatment with a reduced partial pressure of the oxygen.

For this purpose, the carrier layer is introduced into a sintering oven with the protective layer prematerial arranged thereon.

Subsequently, the partial pressure of the oxygen is lowered in the sintering oven, for example, by flushing with a mixture consisting of an inert gas (for example, argon) and, for example, 4 mole percent of hydrogen which has been humidified beforehand at a temperature of 25° C. so that the gas mixture has a water content of approximately 3% by weight.

After the partial pressure of the oxygen has been lowered in the sintering oven in this way, the oven is heated so that the carrier layer with the prematerial arranged thereon is heated to a sintering temperature of at least approximately 750° C., preferably in the range of approximately 750° C. to 800° C. At this sintering temperature, the carrier layer with the prematerial arranged thereon will be held in a first sintering phase for a sintering time of, for example, approximately 3 hours, whereby the layer consisting of the protective layer prematerial will be sintered.

The reduction in the partial pressure of the oxygen causes a degradation of the original spinel structure of the sintering additives, whereby the reactivity will be increased and the compacting process of the protective layer coupled therewith will be accelerated.

The sintering time will be followed by a change-over to an atmospheric partial pressure of the oxygen at a uniform temperature in order to restore the desired and chemically stable spinel structure of the protective layer in a second sintering phase.

In this respect, the temperature of the protective layer or rather of the protective layer prematerial is not reduced to a temperature below 750° C. between the sintering procedure with a reduced partial pressure of the oxygen and the increase in the partial pressure of the oxygen to an atmospheric partial pressure of the oxygen.

The reduced partial pressure of the oxygen during the sintering process is, for example, approximately 10⁻¹⁸.

In the Ellingham diagram illustrated in FIG. 1, the sintering temperature is specified by the line 100 and the reduced partial pressure of the oxygen during the first sintering phase by the line 102.

The intersection point 104 of the lines 100 and 102 characterizes the conditions in the first sintering phase.

This intersection point 104 is, in the Ellingham diagram, below the stability limit 106 of cobalt but above the stability limit 108 of iron, above the stability limit 110 of chromium and above the stability limit 112 of manganese.

The oxides of iron, chromium and manganese are, therefore, stable at the conditions of the first sintering phase relating to temperature and partial pressure of the oxygen whereas the oxides of cobalt are unstable. The cobalt cations therefore display a higher reactivity under these conditions and, therefore, a higher sintering activity whereas undesired elements from the steel of the carrier layer, in particular, chromium are present oxidically. The oxidic form means a higher chemical stability and, therefore, a lower reactivity. As a result, compacting of the protective layer can take place in the first sintering phase without the diffusion of chromium into the protective layer.

As a result of the sintering of the protective layer in a reducing atmosphere (on account of the lowering of the partial pressure of the oxygen) during the first sintering phase, the sintering temperature, which is normally up to 900° C.-1,100° C., can be reduced to approximately 750° C. to 800° C. and the sintering time, which is normally 10 hours, can be shortened to approximately 3 hours. As a result, costs for the manufacture of the bipolar plate can be saved and corrosive damage (degradation) to the carrier layer and the protective layer, in particular, too strong a growth of a chromium oxide layer between the carrier layer and the protective layer at an elevated sintering temperature can be reduced.

The bipolar plate, which is obtained after completion of the second sintering phase (at atmospheric partial pressure of the oxygen), is designated as a whole as 114 and consists of the carrier layer 116, the protective layer 118 with the composition MnCo_{1.9}Fe_{0.1}O₄ and an intermediate layer 120 which is formed between the carrier layer 116 and the protective layer 118 and contains cobalt-manganese-iron-chromate, is illustrated in FIG. 3 in a purely schematic longitudinal section and in FIG. 2 in a real, microscopic longitudinal section.

On account of the comparatively low sintering temperature, only a little chromium diffuses out of the carrier layer 116 into the intermediate layer 120 and so any undesired decrease in the chromium content in the steel of the carrier layer 116 is avoided.

As a result of iron cations being present in the prematerial of the protective layer 118, the microstructure of the protective layer 118 is improved; the protective layer 118 has, in particular, only a few cracks and pores.

The iron cations therefore have a positive effect on the sintering behavior.

The improved microstructure of the protective layer 118, in particular, the decrease in the occurrence of cracks and pores is an indication of a considerable freedom from defects in the protective layer. Since the diffusion of chromium is based, inter alia, on the presence of lattice defects, a lasting retention of chromium in the carrier layer 116 and the intermediate layer 120 is ensured by as defect-free a protective layer 118 as possible.

As a result of the presence of iron cations in the protective layer 118, its thermal coefficient of expansion α is lowered and, therefore, adapted better to the thermal coefficient of expansion of the steel material of the carrier layer 116 and to the thermal coefficient of expansion of other components of the fuel cell unit, in which the bipolar plate 114 is intended to be used. As a result, fewer mechanical tensions result in the fuel cell stack during temperature change cycles.

Since the second sintering phase is carried out at atmospheric partial pressure of the oxygen immediately following the first sintering phase with a reduced partial pressure of the oxygen, no second temperature cycle is required for the manufacture of the bipolar plate 116. This has a positive effect on the costs for the manufacturing process and on the microstructure of the protective layer 118 of the bipolar plate 114.

The thermal coefficient of expansion α of the protective layer 118 manufactured in the manner described above is from approximately 10×10⁻⁶K⁻¹ to approximately 20×10⁻⁶K⁻¹.

The specific electrical conductivity σ of the protective layer 118 is from approximately 0.01 S/cm to approximately 200 S/cm.

1. Bipolar plate for a fuel cell unit, wherein the bipolar plate comprises a carrier layer and a protective layer, wherein the protective layer comprises an oxide system,
wherein the oxide system of the protective layer is an at least ternary oxide system with at least three different types of metal cations.

2. Bipolar plate as defined in claim 1, wherein one type of metal cation is Mn.

3. Bipolar plate as defined in claim 1, wherein one type of metal cation is Co or Cu.

4. Bipolar plate as defined in claim 1, wherein one type of metal cation is Fe or Ni.

5. Bipolar plate as defined in claim 1, wherein the oxide system comprises Mn, Co and Fe cations.

6. Bipolar plate as defined in claim 5, wherein the oxide system has approximately the composition MnCo₂₋ₓFeₓO₄, where 0<x<1.

7. Bipolar plate as defined in claim 6, wherein the oxide system has approximately the composition MnCo_{1.9}Fe_{0.1}O₄.

8. Bipolar plate as defined in claim 1, wherein the oxide system comprises Mn, Cu and Fe cations.

9. Bipolar plate as defined in claim 1, wherein the thermal coefficient of expansion α of the protective layer is from approximately 10×10⁻⁶K⁻¹ to approximately 20×10⁻⁶K⁻¹.

10. Bipolar plate as defined in claim 1, wherein the specific electrical conductivity σ of the protective layer is from approximately 0.01 S/cm to approximately 200 S/cm.

11. Method for manufacturing a protective layer on a bipolar plate for a fuel cell unit, comprising the following method steps:
Applying a layer consisting of a protective layer prematerial to a carrier layer of the bipolar plate;
generating a reduced partial pressure of the oxygen;
increasing the temperature to a sintering temperature;
subsequently increasing the partial pressure of the oxygen;
cooling the carrier layer and the protective layer formed thereon.

12. Method as defined in claim 11, wherein the carrier layer with the prematerial is not cooled between the increase in the temperature to sintering temperature and the increase in the partial pressure of the oxygen.

13. Method as defined in claim 11, wherein the prematerial is applied to the carrier layer in a wet chemical manner.

14. Method as defined in claim 13, wherein the prematerial is sprayed onto the carrier layer.

15. Method as defined in claim 13, wherein the prematerial is applied to the carrier layer in a screen printing process.

16. Method as defined in claim 11, wherein the prematerial comprises at least three different types of metal cations.

17. Method as defined in claim 11, wherein the prematerial comprises Mn cations.

18. Method as defined in claim 11, wherein the prematerial comprises Co and Cu cations.

19. Method as defined in claim 11, wherein the prematerial comprises Fe or Ni cations.

20. Method as defined in claim 11, wherein the prematerial comprises Mn, Co and Fe cations.

21. Method as defined in claim 20, wherein the protective layer generated has approximately the composition MnCo₂₋ₓFeₓO₄, where 0<x<1.

22. Method as defined in claim 21, wherein the protective layer generated has approximately the composition MnCo_{1.9}Fe_{0.1}O₄.

23. Method as defined in claim 11, wherein the prematerial comprises Mn, Cu and Fe cations.
